(19) United States
(12) Patent Application Publication
(10) Pub. No.: US 2018/0373380 A1
(43) Pub. Date: Dec. 27, 2018

(54) OPTICAL CONTROL KEY, OPERATING METHOD THEREOF, AND IMAGE SENSOR

(71) Applicant: PixArt Imaging Inc., Hsin-Chu County (TW)

(72) Inventors: Guo-Zhen WANG, Hsin-Chu County (TW); Han-Chang LIN, Hsin-Chu County (TW)

(21) Appl. No.: 15/634,145

(22) Filed: Jun. 27, 2017

(51) Int. Cl. G06F 3/041; G06F 3/042; G06F 3/01

(52) U.S. Cl. CPC G06F 3/0416; G06F 3/011; G06F 3/042

(57) ABSTRACT

An optical control key including a light source, a pixel array and a processor is provided. The light source is used to illuminate a skin surface. The pixel array has a first pixel region and a second pixel region. The processor is used to identify whether a touch is made by a human body according to pixel data of the first pixel region, and identify human body motion according to pixel data of the second pixel region.

### BACKGROUND

### 1. Field of the Disclosure

This disclosure generally relates to a control switch, more particularly, to an optical control key having a human body recognition function, an operating method thereof, and an electronic device using the same.

### 2. Description of the Related Art

The conventional mechanical button generally has a problem of degraded detection sensitivity with used time. In addition, in order to allow the user to directly press a mechanical button through physical contact, a case of an electronic device employing the mechanical button is generally manufactured with an opening which allows a button cap of the mechanical button to protrude from the opening. However, when the electronic device has the water-proof requirement, in order to prevent water from entering the electronic device through the opening, the manufacturing cost and manufacturing complexity of the case are significantly increased.

Accordingly, the present disclosure provides an optical control key and an operating method thereof to solve the above problem. When the optical control key is provided to an electronic device, a case of the electronic device is not necessary to be manufactured with an opening for the user to physically contact with the optical control key. Furthermore, the optical control key of the present disclosure is able to identify whether an object is a human body or not so as to avoid the error control.

### SUMMARY

The present disclosure provides an optical control key and an operating method thereof that are used to replace the traditional mechanical button to reduce the total cost of a device carrying the optical control key.

The present disclosure further provides an optical control key and an operating method thereof that confirm a human body contact at first and then start to detect a position variation of the human body to improve the control accuracy.

The present disclosure provides an optical control key including a light source, a pixel array and a processor. The light source is configured to illuminate an object. The pixel array is configured to detect light from the object, and has a first pixel region and a second pixel region respectively configured to output pixel data according to detected light. The processor is electrically coupled to the pixel array, and configured to identify whether the object is a human body according to the pixel data of the first pixel region and identify body motion according to the pixel data of the second pixel region.

The present disclosure further provides an operating method of an optical control key. The optical control key includes a light source, a pixel array and a processor. The light source illuminates an object. The pixel array has a first pixel region and a second pixel region and detects light from the object. The operating method includes the steps of: turning on the light source and the first pixel region of the pixel array; identifying, by the processor, whether pixel data of the first pixel region contains an oscillation signal having a specific frequency feature; and turning on the second pixel region of the pixel array when the pixel data of the first pixel region contains the oscillation signal having the specific frequency feature.

The present disclosure further provides an image sensor for actuating commands. The image sensor includes a pixel array and a processing unit. The pixel array is configured to detect light, and has a first pixel region and a second pixel region with different pixel arrangements. The first pixel region and the second pixel region are respectively configured to output first pixel data and second pixel data. The processing unit is configured to receive the first pixel data to determine whether an object being detected includes a specific feature, and receive the second pixel data to determine an operating status of the object, wherein the processor does not output the operating status until the object includes the specific feature.

The present disclosure further provides a user command input device including a bio sensor, a motion sensor and a processor. The bio sensor is configured to identify whether a detected object includes a physiological characteristic. The motion sensor is configured to determine a motion data of the object. The processor is configured to determine an operating status of the object according to the motion data when the detected object is determined as a biological object according to the physiological characteristic.

The optical control key of the present disclosure is adaptable to a portable electronic device to perform the function of, for example, a power key, a sound volume adjustment key, a brightness adjustment key and so on. In addition, by arranging a plurality of optical control keys of the present disclosure, different functions are implementable by the detection combination of different optical control keys. For example, different sequences and combinations of the optical control keys that have detected the existence of a human body are used as a coded lock to provide a kind of lock/unlock means.

It is possible to bury the optical control key of the present disclosure under a transparent region/window of a case of an electronic device. As there is no necessary to form additional opening on the case to dispose the mechanical button, the case can be manufactured as a well-sealed housing to significantly reduce the manufacturing cost and simplify the manufacturing process if the waterproof function is required.

### BRIEF DESCRIPTION OF THE DRAWINGS

Other objects, advantages, and novel features of the present disclosure will become more apparent from the following detailed description when taken in conjunction with the accompanying drawings.

FIG. 1 is a schematic block diagram of a user command input device according to one embodiment of the present disclosure.

FIGS. 2a-2d are schematic diagrams of a pixel array of an image sensor according to some embodiments of the present disclosure.

FIG. 3 is a schematic diagram of an electronic device adopting a user command input device of the present disclosure.

FIG. 4 is a cross sectional view along line 4-4′ of FIG. 3 and an object thereupon.

FIG. 5 is a schematic diagram of pixel data of a first pixel region of an image sensor of a user command input device according to one embodiment of the present disclosure.

FIG. 6 is a flow chart of an operating method of a user command input device according to one embodiment of the present disclosure.

### DETAILED DESCRIPTION OF THE EMBODIMENT

It should be noted that, wherever possible, the same reference numbers will be used throughout the drawings to refer to the same or like parts.

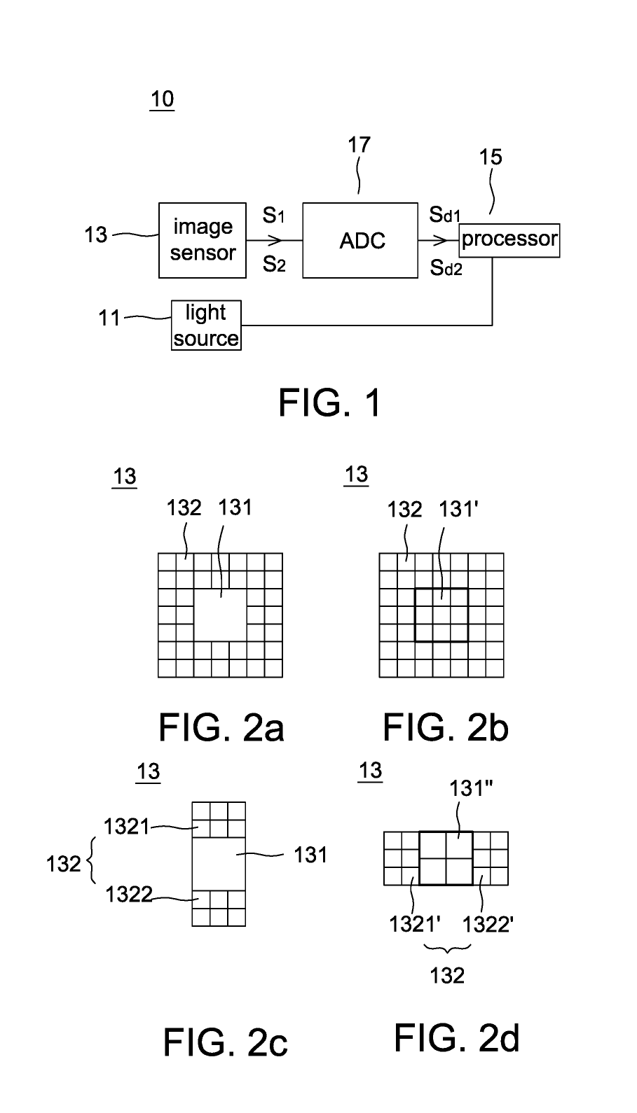

Referring to FIG. 1, it is a schematic block diagram of a user command input device according to one embodiment of the present disclosure. The user command input device in this embodiment is an optical control key 10, which includes a light source 11, an image sensor 13, a processor 15 and an analog-to-digital converter (ADC) 17. When the optical control key 10 of the present disclosure is applied to a smart phone, the light source 11 and the image sensor 13 are additionally disposed devices independent from the proximity sensor and the camera module.

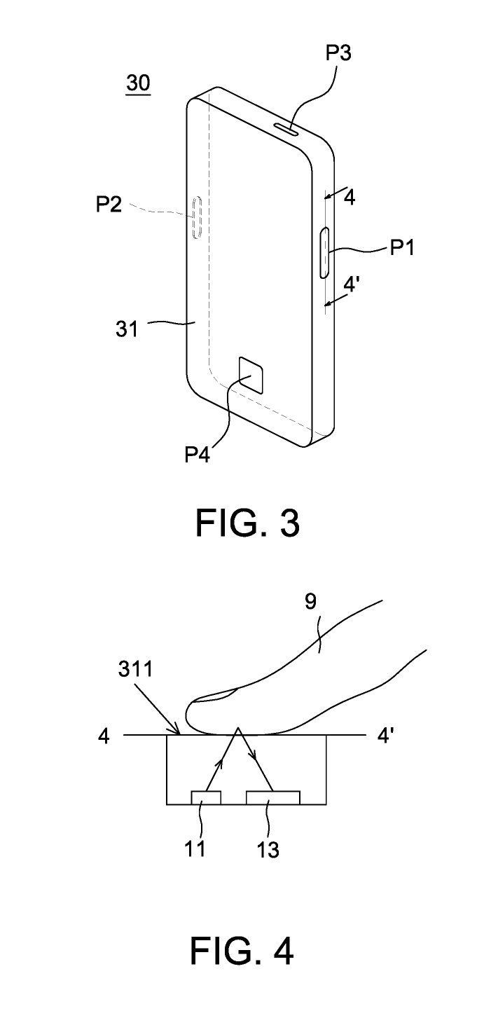

The optical control key 10 of the present disclosure is also applicable to any electronic device (e.g., element 30 shown in FIG. 3) employing a traditional mechanical button, e.g., tablet computers, notebook computers, home appliances, vehicle electronic devices and so on, to replace the traditional mechanical button. Accordingly, it is not necessary to form an opening on a case of the electronic device. In addition to the waterproof and dustproof functions, the case may be designed to have a smooth appearance.

It should be mentioned that although the ADC 17 is shown to be connected outside of the image sensor 13 and the processor 15 in FIG. 1, it is only intended to illustrate but not to limit the present disclosure. In other embodiments, it is possible that the ADC 17 is included in the image sensor 13 or the processor 15 without being limited to that shown in FIG. 1. In addition to perform the post-processing on pixel data generated by the image sensor 13, the processor 15 further controls the image capturing of the image sensor 13 and the illumination of the light source 11. Therefore, each of the image sensor 13 and the light source 11 has an electrical contact for electrically coupling with the processor 15.

As the optical control key 10 of the present disclosure has the function of detecting physiological characteristics, e.g., detecting the photoplethysmogram (PPG) signal and/or heartbeat, the light source 11 preferably emits light suitable to be absorbed by skin tissues of the human body. For example, the light source 11 is selected from a red light emitting diode (LED), a red light laser diode, an infrared light LED and an infrared light laser diode, but not limited thereto. The light source 11 is any proper light source capable of emitting red light and/or infrared light. The light source 11 is used to illuminate an object (e.g., a finger 9 shown in FIG. 4). When the object is the skin of a human body, a part of light emitted by the light source 11 enters the skin, passes through skin tissues and then comes out from the skin again. Therefore, the light passing through the skin tissues is affected by the partial absorption of the skin tissues such that emergent light intensity coming out from the skin has a fluctuation feature with time.

The intensity variation of the emergent light may be referred to U.S. Patent Publication No. US 2016-0089086, entitled “Heart rate detection module, and detection and denoising method thereof”, assigned to the same assignee of the present application, and the full disclosure of which is incorporated herein by reference.

In some embodiments, the processor 15 also controls the light source 11 to sequentially emit light at different brightness, and further calculates a differential image of two image frames corresponding to the different brightness so as to eliminate noises.

The image sensor 13 includes a pixel array of, for example, a charge coupled device (CCD) image sensor or a complementary metal oxide semiconductor (CMOS) image sensor, and used to detect light from the object. The pixel array of the image sensor 13 includes a first pixel region and a second pixel region to respectively output pixel data according to the detected light, wherein the difference between the first pixel region and the second pixel region is mainly on their different light sensitivity, e.g., photodiodes in the pixel having different sizes. The larger the size is, and the greater optical sensitivity is obtainable.

Referring to FIGS. 2a-2d, they are schematic diagrams of the pixel array of the image sensor 13 according to some embodiments of the present disclosure.

As shown in FIG. 2a, the pixel array of the image sensor 13 includes a first pixel region 131 and a second pixel region 132, and the first pixel region 131 includes only one pixel. In this embodiment, the second pixel region 132 is arranged surrounding the first pixel region 131, e.g., directly adjacent to the first pixel region 131. Meanwhile, as the first pixel region 131 is used to detect PPG signal and/or heartbeat signal, a size of a single pixel of the first pixel region 131 is larger than a size of each pixel of the second pixel region 132. More specifically, under the same emission intensity of the light source 11, a size of the photodiode in each pixel of the second pixel region 132 is smaller than that in each pixel of the first pixel region 131. Although said small photodiode is able to detect light intensity to generate gray value, the light sensing ability thereof is not good enough to detect the PPG signal, i.e. the generated gray value not being able to reflect the intensity variation due to the light absorption of body tissues. On the other hand, a size of the photodiode in the pixel of the first pixel region 131 is arranged large enough to be able to detect the PPG signal, i.e. the generated gray value being able to reflect the intensity variation due to the light absorption. In other words, a size of the single pixel of the first pixel region 131 is designed according to the used emission intensity of the light source 11. If the light source 11 emits weaker light, the size or sensitivity of the single pixel of the first pixel region 131 is arranged larger.

As shown in FIG. 2b, in one embodiment the pixel array of the image sensor 13 includes a first pixel region 131′ and a second pixel region 132, and a size of each pixel of the first pixel region 131′ is equal to that of the second pixel region 132. The pixel data of each pixel of the first pixel region 131′ is summed using hardware circuit before being outputted from the image sensor 13 or summed using software or hardware of the processor 15 connected downstream after being outputted from the image sensor 13 to detect the PPG signal. In this embodiment, the emission intensity of the light source 11 is arranged to allow each pixel of the first pixel region 131′ to be able to detect the PPG signal. The purpose of calculating the summation is to improve the signal to noise ratio of the pixel data.

In the embodiment that only predetermined one-dimensional object motion is detected, the second pixel region 132 is arranged only at two opposite sides of the first pixel region 131, e.g. at upper and lower sides of the first pixel region 131 in FIG. 2c or at left and right sides of the first pixel region 131″ in FIG. 2d. A size of each pixel of the first pixel region 131 is arranged to be identical to or larger than that of the second pixel region 132 as shown in FIGS. 2a-2d according to different applications. In FIG. 2d, the summation of the pixel data of every pixel in the first pixel region 131″ is performed to improve the detection sensitivity. As mentioned above, the summation is performed by the image sensor 13 or by the processor 15.

The ADC 17 is used to convert analog pixel data S1 outputted by the first pixel region 131 of the image sensor 13 into digital pixel data Sd1, and convert analog pixel data S2 outputted by the second pixel region 132 of the image sensor 13 into digital pixel data Sd2. As the processor 15 is used to process the digital signal, in the descriptions herein sometimes the pixel data from the first pixel region 131 is referred to Sd1 and the pixel data from the second pixel region 132 is referred to Sd2 for illustration purposes. In addition, it should be mentioned that although the image sensor 13 is shown to transfer the pixel data through one signal line in FIG. 1, in other embodiments the image sensor 13 transfers the pixel data of the first pixel region 131 and second pixel region 132 respectively through different signal lines.

The processor 15 is a processing unit, e.g., a digital signal processor (DSP), a microcontroller (MCU), a central processing unit (CPU) or an application specific integrated circuit (ASIC), capable of processing digital image data. The processor 15 is electrically coupled to the light source 11 and the image sensor 13, and used to identify whether an object 9 (as shown in FIG. 4) is a human body according to the pixel data Sd1 of the first pixel region 131, and identify human body motion according the pixel data Sd2 of the second pixel region 132 if the object 9 is a human body. For example, the processor 15 identifies whether the pixel data Sd1 of the first pixel region 131 contains an oscillation signal having a specific frequency feature, e.g., a fixed frequency, but not limited to. As a heartbeat range of a human is generally between 50 times/min and 120 times/min, and when the specific frequency feature, such as a fixed frequency is between 0.8 Hz and 2 Hz, the processor 15 identifies the object 9 as a human body. On the contrary, when the processor 15 identifies that the object 9 is not a human body, no further operation is executed so as to prevent error control.

In addition, the processor 15 further performs the filtering and denoising processes on the pixel data Sd1 of the first pixel region 131 to increase the identification accuracy. However, in the embodiment that the heartbeat needs not to be calculated accurately, the optical control key 10 does not perform the filtering or denosisng so as to reduce the operation resources.

For example referring to FIGS. 3-4, FIG. 3 is a schematic diagram of an electronic device adopting the user command input device of the present disclosure, and FIG. 4 is a cross sectional view along line 4-4′ of FIG. 3 and an object 9 thereupon. The electronic device 30 includes a case 31 which is made of metal, glass, plastic or a combination thereof without particular limitations. The case 31 has a transparent region 311 (referring to FIG. 4), and it is possible to arrange the transparent region 311 at different positions of the case 31, e.g., at positions P1, P2, P3 and/or P4 shown in FIG. 3 according to different applications. The case 31 and the transparent region 311 may be manufactured integrally or separately without particular limitations.

The optical control key 10 of this embodiment is disposed under the transparent region 311 to perform the detection through the transparent region 311. For example, the light source 11 of the optical control key 10 projects light toward the transparent region 311, and the transparent region 311 is made in a way that the projected light from the light source 11 is able to penetrate therethrough. The image sensor 13 of the optical control key 10 detects light from the transparent region 311 to output pixel data. In the application of FIG. 4, the processor 15 is the CPU of the electronic device 30 or an additional microcontroller independent from the CPU of the electronic device 30.

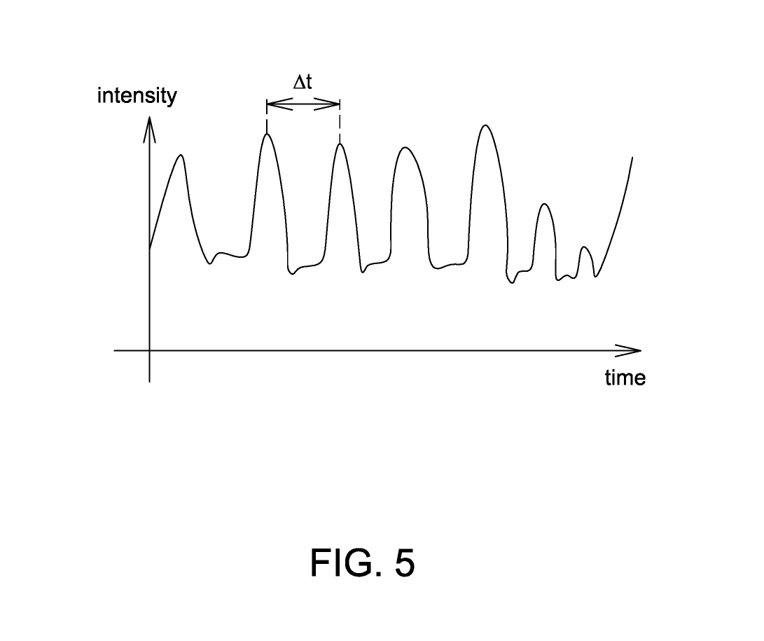

Referring to FIG. 5, it is a schematic diagram of pixel data Sd1 detected by a first pixel region 131 of an image sensor 13 of an optical control key 10 according to one embodiment of the present disclosure. When an object 9 (e.g., finger) is put on the transparent region 311, the light emitted by the light source 11 passes through skin tissues and a light signal whose intensity changes with time as shown in FIG. 5 is generated. The processor 15 calculates, in the time domain or frequency domain, and identifies whether the pixel data Sd1 outputted by the first pixel region 131 contains an oscillation signal of a specific frequency feature, e.g., a fixed frequency between 0.8 Hz and 2 Hz. For example, the processor 15 calculates a reciprocal of a time interval At between two peaks to obtain the frequency, or converts the data in FIG. 5 into frequency domain using, for example, Fast Fourier Transform (FFT) at first and then confirms whether the converted frequency data contains said specific frequency feature, wherein the method of converting data using FFT or other method is known and thus details thereof are not repeated herein.

In some embodiments, in order to use the optical control key 10 of the present disclosure as a power button, the light source 11 and the first pixel region 131 of the image sensor 13 are always turned on. For example, when the electronic device 30 includes a display screen, the light source 11 and the first pixel region 131 are always on, i.e. the light source 11 emitting light continuously in a predetermined intensity and the first pixel region 131 outputting pixel data at a scan frequency, even if the electronic device 30 is in a sleep mode during which the display screen is shut down. Meanwhile, in order to reduce the power consumption to extend the standby time of the electronic device 30, the emission intensity of the light source 11 is arranged as low as possible.

As mentioned above, the light sensitivity of the first pixel region 131 of the image sensor 13 is arranged to be able to at least detect the PPG signal under the emission strength of the light source 11. Meanwhile, in order to reduce the power consumption as much as possible, the second pixel region 132 of the image sensor 13 is preferably turned off before the processor 15 confirms the object 9 as a human body. That is, the second pixel region 132 is turned on only when the processor 15 identifies that the pixel data Sd1 of the first pixel region 131 contains an oscillation signal having the specific frequency feature. Otherwise, the second pixel region 132 is always turned off. Said turned off is referred to that, for example, every photodiode in the second pixel region 132 is deactivated or the detection result of the photodiode is not read, which is implemented by controlling switching devices.

After the object 9 is identified as a human body, the second pixel region 132 is turned on, e.g., by controlling the switching devices, and the processor 13 then identifies human body motion according to the gray value variation or image features of pixel data of pixels at different locations in the second pixel region 132.

For example referring to FIG. 2c, it shows that the second pixel region 132 includes a first area 1321 and a second area 1322. The processor 15 is able to identify the object motion along a connecting line between the first area 1321 and the second area 1322 according to a sequence of the gray value variation of the first area 1321 and the second area 1322. For example, when identifying that gray values of pixels of the first area 1321 change from high to low and gray values of pixels of the second area 1322 change from low to high, the processor 15 identifies that the object 9 moves from the first area 1321 to the second area 1322. The movement from the second area 1322 to the first area 1321 is identifiable using a similar way.

In another embodiment, the processor 15 identifies the motion direction according to image features (e.g., feature points, lines, edges or image quality) of the first area 1321 and the second area 1322, e.g., comparing two images acquired at different times to calculate a motion vector of the image features. When a direction of the object motion is confirmed, the processor 15 adjusts the voice volume, screen brightness or other controllable values of the electronic device 30, which are used to be controlled by a traditional mechanical button, according to the confirmed direction.

In some embodiments, the processor 15 turns off the first pixel region 131 at the time that the second pixel region 132 is turned on, and when the gray values of the second pixel region 132 do not change within a predetermined time interval, the first pixel region 131 is turned on again to confirm the existence of the object 9.

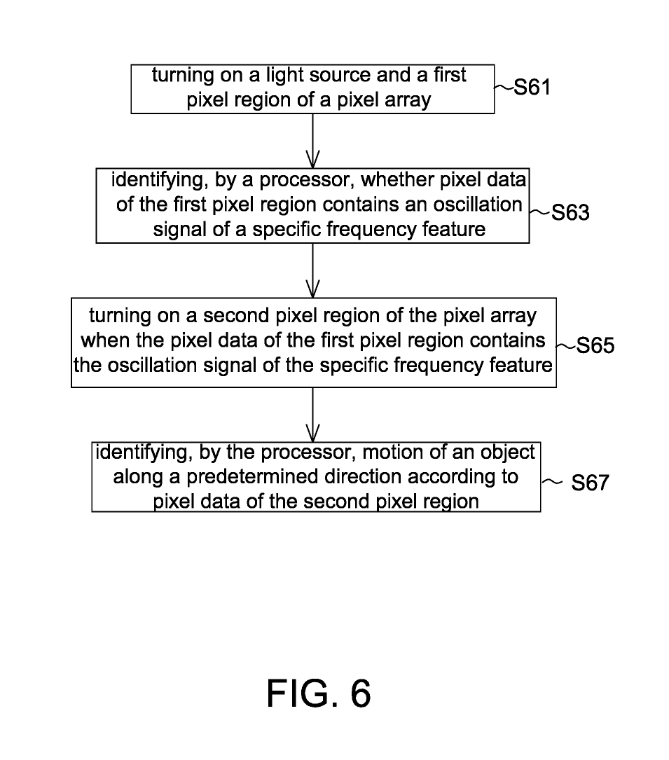

Please referring to FIG. 6, it is a flow chart of an operating method of a user command input device according to one embodiment of the present disclosure. As mentioned above, one embodiment of the user command input device is an optical control key 10 which includes a light source 11, an image sensor 13 and a processor 15. The light source 11 is used to illuminate an object 9. The image sensor 13 is used to detect light from the object 9, and includes a first pixel region 131 and a second pixel region 132 for outputting pixel data according to the detected light.

The operating method of this embodiment includes the steps of: turning on a light source and a first pixel region of a pixel array (Step S61); identifying, by a processor, whether pixel data of the first pixel region contains an oscillation signal of a specific frequency feature (Step S63); turning on a second pixel region of the pixel array when the pixel data of the first pixel region contains the oscillation signal of the specific frequency feature (Step S65); and identifying, by the processor, motion of an object along a predetermined direction according to pixel data of the second pixel region (Step S67).

Referring to FIGS. 1-6, details of one example of the operating method of this embodiment are described hereinafter.

Step S61: The optical control key 10 is applicable to, for example, a smart phone, and when the power of the smart phone is turned on, the light source 11 and the first pixel region 131″ (as shown in FIG. 2d) of the image sensor 13 are turned on in operation. In another embodiment, when the smart phone uses the optical control key 10 of the present disclosure as a power button, the light source 11 and the first pixel region 131″ of the image sensor 13 are always turned on in operation as long as the optical control key 10 is able to draw power from the battery.

Step S63: After receiving pixel data (analog data or digital data depending on a position of the ADC 17) from the first pixel region 131″, the processor 15 identifies whether the pixel data contains an oscillation signal of a specific frequency feature, wherein said specific frequency feature is arranged as a frequency range of a human heartbeat. In order to confirm whether a human body is detected as soon as possible, the processor 15 obtains a result within a time interval between two peak values once the two peaks are detected. For example, if two peaks (as shown in FIG. 5) are detected within a time interval Δt=500 to 1200 ms, the pixel data is identified to contain the physiological characteristics of a human body. It is appreciated that peak values of the two peaks are preferably larger than a predetermined threshold to avoid the error identification. In another embodiment, the processor 15 confirms the existence of human body using more than two peaks.

Step S65: As mentioned above, to save power, the second pixel region 132 of the image sensor 13 is not turned on together with the light source 11 and the first pixel region 131″. The second pixel region 132 is turned on only when the pixel data Sd1 of the first pixel region 131″ contains the oscillation signal of the specific frequency feature. However, in an electronic device having a lower requirement in consuming power, it is possible that the second pixel region 132 is turned on together with the first pixel region 131″. In addition, when the optical control key 10 is used as a power button and the pixel data Sd1 of the first pixel region 131″ is identified to contain the oscillation signal of the specific frequency feature, the second pixel region 132 is not turned on immediately but turned on after the startup procedure is accomplished.

Step S67: After the second pixel region 132 is turned on, the processor 15 identifies object motion along a connecting line between a first area 1321′ and a second area 1322′ of the second pixel region 132 according to pixel data Sd2. For example, if the optical control key 10 is arranged at the position P1 (as shown in FIG. 3) of the electronic device 30 and the direction of a connecting line between the first area 1321 and the second area 1322 of the second pixel region 132 is along the upper-down direction of the electronic device 30, the object motion is in one-dimensional direction along the vertical direction. If the optical control key 10 is arranged at the position P3 of the electronic device 30 and the direction of a connecting line between the first area 1321′ and the second area 1322′ of the second pixel region 132 is along the left-right direction of the electronic device 30, the object motion is in one-dimensional direction along the horizontal direction. If the optical control key 10 is arranged at the position P4 of the electronic device 30 and the image sensor 13 is arranged as FIG. 2a, the object motion is in two-dimensional directions along the vertical and horizontal directions.

In the embodiments of the present disclosure, the pixel data of the first pixel region 131 is only used to detect an oscillation signal of a specific frequency feature but not used to detect object motion. The pixel data of the second pixel region 132 is only used to detect object motion but not used to detect an oscillation signal of a specific frequency feature. The processor 15 performs the above detection using hardware and/or software (stored in a memory).

In other embodiments, the electronic device 3 are disposed with multiple optical control keys 10, e.g., at positions P1 and P2. Only when both of the two optical control keys 10 detect the human body, the electronic device 10 performs the corresponding operation, wherein said corresponding operation is predetermined and stored in a memory.

By using the optical control key 10 of the present disclosure, the electronic device 30 does not use any conventional mechanical button. It is possible to replace functions of conventional mechanical buttons by identifying whether one or multiple optical control keys 10 have identified the human body and/or identifying a detected sequence or combination of the multiple optical control keys 10 that have identified the human body.

In one embodiment, the image sensor 13 is used to actuate commands, e.g., control commands corresponding to gestures in different directions to, for example, turn pages, move icons or images, change image or sound features or the like. The image sensor 13 includes a pixel array, e.g. the pixel array shown in FIGS. 2a-2d, and a processing unit. For example, the pixel array and the processing unit form a sensor chip, and the processing unit is a digital signal processor (DSP) integrated in the image sensor 13.

The pixel array 13 is used to detect light, and has a first pixel region, e.g., 131, 131′ or 131″ in FIGS. 2a-2d, and a second pixel region, e.g. 132 in FIGS. 2a-2d, with different pixel arrangements. The first pixel region and the second pixel region are respectively used to output first pixel data, e.g., S1, and second pixel data, e.g., S2. As mentioned above, said different pixel arrangements are referred to that the first pixel region and the second pixel region have different pixel sizes or different optical sensitivity.

The processing unit is used to receive the first pixel data to determine whether an object being detected includes a specific feature. As mentioned above, if the object is a part of a human body (e.g., finger 9 in FIG. 4), the specific feature is a frequency range between 0.8 Hz and 2 Hz as an example. The processing unit also receives the second pixel data to determine an operating status of the object, e.g., the moving direction and/or moving speed of the object. Method of the processing unit determining whether an object being detected includes a specific feature and determining an operating status of the object are similar to that of the processor 15 mentioned above, and thus details thereof are not repeated herein.

In this embodiment, the processing unit does not output the operating status until the object is determined to include the specific feature. As mentioned above, the first pixel region is used to detect whether the object is a human body, and the second pixel region is turned on to detect the operating status only when the object is determined as the human body.

In another embodiment, the user command input device of the present disclosure includes a bio sensor and a motion sensor. For example, the bio sensor has the first pixel region 131, 131′ or 131″, and the motion sensor has the second pixel region 132 in FIGS. 2a-2b. In one embodiment, the bio sensor and the motion sensor are integrated in a same pixel array. In an alternative embodiment, the bio sensor and the motion sensor are individual image sensors instead of being integrated in a same pixel array.

Similar to the function of the first pixel region mentioned above, the bio sensor is used to identify whether a detected object includes a physiological characteristic. As mentioned above, if the detected object is a human body (e.g., finger 9 in FIG. 4), the detected object has a heart rate such that the physiological characteristic is a frequency within a predetermined frequency range.

Similar to the function of the second pixel region mentioned above, the motion sensor is used to determine a motion data of the object. As mentioned above, the motion sensor is not turned on before the detected object is identified to include the physiological characteristic. In some embodiments, the bio sensor is always turned on and the motion sensor is turned on only after the detected object is identified as a biological object.

The processor, e.g., processor 15 shown in FIG. 1, is used to determine an operating status of the object according to the motion data when the detected object is determined as a biological object according to the physiological characteristic. As mentioned above, the detected object is identified as a biological object according to the frequency of the detected optical signal, e.g., PPG signal; and the operating status of the object includes a moving direction and/or a moving speed of the object in a predetermined direction. As mentioned above, the bio sensor preferably has a higher optical sensitivity than the motion sensor, e.g., the bio sensor having a larger pixel size than and the motion sensor.

It is appreciated that the values and element ratio in the above embodiments and drawings are only intended to illustrate but not to limit the present disclosure. The object 9 is not limited to a finger and may be any skin surface as long as the processor 15 is able to identify the oscillation signal having a predetermined frequency according to pixel data of the first pixel region 131 of the image sensor 13. Therefore, when the processor 15 is not able to identify that the pixel data contains said predetermined frequency, the optical control key 10 cannot be trigger even using a conductor.

As mentioned above, the conventional mechanical button has the problems of usage depletion and increasing cost of the carrying device. Therefore, the present disclosure further provides an optical control key (as shown in FIG. 1) and an operating method thereof (as shown in FIG. 6) as well as an electronic device using the same (as shown in FIG. 3) that confirm a human body touch and recognize a gesture of the human body through different pixels of a pixel array. As it is not necessary to arrange any opening on a case of the electronic device, the total cost and the manufacturing complexity are effectively reduced. Furthermore, it is possible to use the optical control key of the present disclosure as a power key. Therefore, when a device carrying the optical control key is under the sleep mode, the physiological characteristic is continuously detected to be served as another choice of awaking the device.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. An optical control key, comprising:
a light source configured to illuminate an object;
a pixel array configured to detect light from the object, and having a first pixel region and a second pixel region respectively configured to output pixel data; and
a processor, electrically coupled to the pixel array, configured to identify whether the object is a human body according to the pixel data of the first pixel region and identify body motion according to the pixel data of the second pixel region.

2. The optical control key as claimed in claim 1, wherein the second pixel region is turned off before the human body is identified by the processor.

3. The optical control key as claimed in claim 1, wherein the second pixel region is arranged surrounding the first pixel region.

4. The optical control key as claimed in claim 1, wherein a size of each pixel of the first pixel region is larger than that of the second pixel region.

5. The optical control key as claimed in claim 4, wherein the first pixel region has only one pixel.

6. The optical control key as claimed in claim 1, wherein when the processor identifies that the pixel data of the first pixel region contains an oscillation signal of 0.8 Hz to 2 Hz, the object is identified as the human body.

7. The optical control key as claimed in claim 1, wherein the processor is configured to identify the body motion according to a gray value variation or image features of pixel data of pixels at different positions in the second pixel region.

8. An operating method of an optical control key, the optical control key comprising a light source, a pixel array and a processor, the light source illuminating an object, the pixel array having a first pixel region and a second pixel region and detecting light from the object, the operating method comprising:
turning on the light source and the first pixel region of the pixel array;
identifying, by the processor, whether pixel data of the first pixel region contains an oscillation signal having a specific frequency feature; and
turning on the second pixel region of the pixel array when the pixel data of the first pixel region contains the oscillation signal having the specific frequency feature.

9. The operating method as claimed in claim 8, further comprising:
identifying, by the processor, motion of the object in a predetermined direction according to pixel data of the second pixel region.

10. The operating method as claimed in claim 8, wherein the specific frequency feature is a fixed frequency between 0.8 Hz and 2 Hz.

11. The operating method as claimed in claim 8, wherein
the second pixel region is arranged surrounding the first pixel region; and
a size of each pixel of the first pixel region is larger than that of the second pixel region.

12. The operating method as claimed in claim 8, wherein the first pixel region has only one pixel.

13. The operating method as claimed in claim 8, further comprising:
calculating, by the processor, the specific frequency feature in a time domain or a frequency domain using the pixel data of the first pixel region.

14. An image sensor for actuating at least one command, the image sensor comprising:
a pixel array configured to detect light, and having a first pixel region and a second pixel region with different pixel arrangements and respectively configured to output first pixel data and second pixel data; and
a processing unit configured to receive the first pixel data to determine whether an object being detected includes a specific feature, and receive the second pixel data to determine an operating status of the object,
wherein the processing unit does not output the operating status until the object includes the specific feature.

15. The image sensor as claimed in claim 14, wherein said different pixel arrangements are referred to that the first pixel region and the second pixel region have different pixel sizes.

16. The image sensor as claimed in claim 14, wherein said different pixel arrangements are referred to that the first pixel region and the second pixel region have different optical sensitivity.

17. A user command input device, comprising:
a bio sensor configured to identify whether a detected object includes a physiological characteristic;
a motion sensor configured to determine a motion data of the object; and
a processor configured to determine an operating status of the object according to the motion data when the detected object is determined as a biological object according to the physiological characteristic.

18. The user command input device as claimed in claim 17, wherein the motion sensor is not turned on before the detected object is identified to include the physiological characteristic.

19. The user command input device as claimed in claim 17, wherein the physiological characteristic is a frequency within a predetermined frequency range.

20. The user command input device as claimed in claim 17, wherein the bio sensor has a larger pixel size than and the motion sensor.
